(19) United States
(12) Patent Application Publication
(10) Pub. No.: US 2004/0039772 A1
(43) Pub. Date: Feb. 26, 2004

(54) Methods and arrangements in a telecommunication network

(76) Inventors: Angel Boveda De Miguel, Madrid (ES); Manuel Lorenzo Hernandez, Madrid (ES); Jens Jonsson, Linkoping (SE); Anders Eriksson, Linkoping (SE); Ingvar Berg, Linkoping (SE); Lars Jensen, Stockholm (SE); Andreas Torstensson, Karlskrona (SE); Niklas Bratt, Karlskrona (SE)

Correspondence Address: JENKENS & GILCHRIST, PC, 1445 ROSS AVENUE, SUITE 3200, DALLAS, TX, 75202, US

(21) Appl. No.: 10/394,566

(22) Filed: Mar. 21, 2003

Related U.S. Application Data
(63) Continuation-in-part of application No. 10/387,633, filed on Mar. 13, 2003.

(30) Foreign Application Priority Data
Apr. 25, 2002 (SE) 0201287-0

(51) Int. Cl. G06F 15/16

(52) U.S. Cl. 709/201

(57) ABSTRACT

The present invention relates generally to the field of distribution of services in communication networks and particularly to provisioning of services in a communication network with a plurality of service systems, service providers and service enablers. The system according to the invention provides a system component register (SCR) comprising service information relating to a plurality of services in the service network, said service information in stored in service data records, one for each service or group of services. Each service data records comprise at least one service instance field identifying a service instance for the specific service or group of services; and, if the specific service or group of services is a complex service or utilizes a shared resource, at least one dependency field defining dependencies for the specific service or group of services to at least one other service system in the service network.

### FIELD OF THE INVENTION

The present invention relates generally to the field of distribution of services in communication networks and particularly to provisioning of services in a communication network with a plurality of service systems, service providers and service enablers.

### BACKGROUND OF THE INVENTION

Traditionally communication networks such as mobile telephony networks (PLMN), fixed circuit-switched networks (PSTN) and data communication networks have been separate systems. The telecommunication networks have been characterized as vertically integrated, meaning that applications and services are closely tied to the technique of transport. The mobile system GSM for example, provides a set of services and applications, those appearance, advantages and limitations, at least to a large extent, is given by the communication technique. A fixed telephone network (PSTN) has provided a different set of services and applications, closely linked to the communication technique used in the system, and the services often differ in usage and appearance from a similar service in a PLMN. Services that appears similar to the end-user, may, due to the same close ties to the technique, be implemented very differently in the different networks.

The close link between the services and the communication technique has in addition been an important reason for the fact that the network operator has also been the dominating provider of services to the end-user. To provide a service, knowledge of, and access to, the complete network, has been crucial. A vertically integrated network is depicted in FIG. 1.

There is an increasing demand for a larger variation of services, complex services and to allow competition among service provider. At the same time has the tele- and data communication networks evolved. The new generations of communication systems integrates different communication technologies such as cellular telephony and IP-based data communication. The new systems are often pictured as horizontally layered, with e.g. an access layer, a core layer and a service layer. In FIG. 2 a layered communication system is depicted. In this scenario existing and new players for example operators, service providers, service enablers, content providers and application (Internet) service providers interact to offer the end-user a large variety of services. The service are offered and managed in the service layer, which has the form of a network, the service network 200. The service network 200 interacts with the core network 210, which typically has a IP architecture and provides transport and switching functionality. From the core network it is possible to communicate with a plurality of access networks. The access networks may be of various kinds, including cellular systems 220 with different capacity and characteristics such as GSM or UMTS, fixed telephony (PSTN) 230, IP based data communication 240, and cable TV 250. The service network 200 preferably has an open architecture, for example Open Service Architecture, OSA and an open interface, for example OSA application program interface, API, as to enable the multitude of players to interact for providing services to the end-users. A comparison between vertically integrated networks and layered networks may be found in Ericsson Review No. 2, 2001 pages 62-67.

The offered services may preferably by tailored after the end-user's personal preference, the access method (mobile system, fixed system etc), characteristics of the accessing terminal (e.g. the capacity of a mobile terminal), subscription type etc. Although e.g. the access method will affect the execution of the service in the service network, many parts of the execution of a service will be similar or identical regardless of e.g. the access method. Hence, a service provider may use the same “building blocks” to construct different services adapted for different end-users. A building block may e.g. be a directory service, a message service or a positioning tool, which also are referred to as service enablers. The openness of the service networks as well as the possibility to use building blocks for more than one particular service are perceived as key factors in attracting both players like operators, service providers and service enablers and end-users to develop and use, respectively, new services.

The offered service will range from basic telephony services such as establishing a call between two mobile subscribers, to complex services involving different access networks, one or more Internet applications and security services. Complex services may include service using positioning, messaging and e-commerce. A positioning based service could e.g. be finding a hotel near the position of the end-user. Such a service could involve using the positioning tools of the mobile system via the mobile positioning centre, one or more Internet applications for finding and categorizing hotels in a certain area, applications that transforms the information to a format suitable for presentation on the terminal of the end-user, e.g. WAP, and e-commerce applications facilitating secure booking and payment of a room.

Another example of complex services relates to what is known as fleet management. Information on position of each individual user in a selected group of users is presented to one, or all, of the users in the group. The position of each user is provided by the positioning system. A user may this way get updated information on the positions of all others in the group. This type of services may be useful for example in managing a fleet of delivery vehicles. To offer and to execute such services a large number of interface between different service systems are required, and as different service systems may be provided by different service enablers, the need for service network and a service network that has an open architecture and standardized interfaces should be obvious.

The multitude of services provided in a service network by a multitude of service providers, enablers etc., the end-users spread in different access networks and with the demand of personalized services and different forms of payment, will increase the demand of correct end-user related and service related data and immediate access to this data is crucial. In the today existing networks data related to the end-users are scattered throughout the network, and in many cases redundant end-user data is stored and used. Similarly data relating to services are spread primarily in the different service system. The scattered storing of the data and the redundancy makes it difficult to retrieve and update the information. It will, in the existing networks with their scattered data, particularly be difficult to implement and to ensure a stable functionality of complex services. One drawback with the scattered data may be illustrated with the example of a end-user ending its subscription to one complex service, which for example relies on a positioning service. All data relating to that subscriber is then removed from the service system that provides the positioning service. The end user may still want to use other complex services that uses the positioning, but since the end-user related data has been removed from the service system that provides the positioning service, these other complex service will lack crucial end-user related data. The complex services may in some case not be possible to perform, and in other cases, if the end-user data still can be retrieved from somewhere in the network, the execution of the complex service will be delayed and/or result in increased traffic load. The problems related to the scattering of end-user and subscriber data is addressed in the application XXX, by the same applicant. This application is hereby incorporated by reference.

Not only the user and subscriber data have the risk of being scattered in the service network, but also information on the available services themselves may easily degenerate in a large service network. This service data includes the information needed for service provisioning as well as executing a service. A typical service network might contain thousand of services and new services, or combination of services, will constantly emerge as well as less successful services will disappear. In the scenario with service data scattered in the service network it will be difficult for eg. an operator to keep track of all service information needed in order to perform the services an end-user subscribes to, and to offer the end-user new services. Further, it will be of crucial importance to provide new services fast and accurate, since the “lifetime” of certain service will be short.

In the case of complex services with for example different service enablers providing the different “building blocks” of a complex service the present scenario with scattered service data will make it difficult and slow, or even impossible, for the provider of the complex service to be updated on changes in the “building blocks”, changes that might adversely effect the performance of the complex service.

The problems with existing handling of services in the service network may be summarized as follows:

a) Service are deployed through different service systems in the service network and the relations between the service systems the services are not easily retrieved;

b) New services should be offered quickly to the end-users; and

c) Dependencies between the different service systems used by a complex service are not readily available.

### SUMMARY OF THE INVENTION

The objective problem is, in a service network for providing complex service and/or a multitude of services, to provide a method, data model and system for provisioning of services.

The problem is solved by the system as defined in claim 1, the data model according to claim 9 and the method as defined in claim 17.

The system according to one embodiment of the invention provides a system component register (SCR) comprising service information relating to a plurality of services in the service network, and service data records storing said service information, one for each service or group of services. Each service data records comprise at least one service instance field identifying a service instance for the specific service or group of services; and, if the specific service or group of services is a complex service or utilizes a shared resource, at least one dependency field defining dependencies for the specific service or group of services to at least one other service system in the service network.

The data model according to one embodiment of the invention is adapted to be used for provisioning services in a service network with a plurality of service systems for providing a plurality of services. The service data model comprises service information relating to a plurality of services in the service network, said service information is structured in service data objects, one for each service or group of services, and each service data object comprise: at least one service instance object identifying a service instance for the specific service or group of services; and at least one dependency object defining dependencies for the specific service or group of services to at least one other service system in the service network, if the specific service or group of services is a complex service or utilizes a shared resource.

The method according to the invention for provisioning services in a service network, wherein service information relating to a plurality of services are stored in a system component register (SCR), comprises the steps of:

deploying the service in the service network by providing a first representation of the service in the SCR;

providing the service by providing a second representation of the service in the SCR, the second representation of the service being a specialization of the first representation. The method may further comprise the step of:

offering the service to end-users, by providing a third representation of the service in a common subscriber/user database (CSD), the third representation of the service being an specialization of the second representation of the service.

Thanks to the service component register according to the invention and the service data records, structured according to the service data model of the invention a centralized provisioning of services in the service network is facilitated. By these arrangements a stable environment is created in the service network and a fast and secure provisioning of services is ensured.

Definitions

Service Network (SN)—corresponds to the service layer in the horizontally layered view of a communication system. Nodes, and a plurality of service systems, necessary to provide end-user services are considered as parts of the service network. Exactly which nodes which are considered to belong to the service network will depend on the implementation.

Service system—System for providing a service, or part of a service. The service system typically belongs to the service network. A service system may use (communicate with) other service systems to provide a specific service to a end-user, and a complex service may need to use a plurality of service system to execute the service. A service system may provide one or more different services or parts of services.

Service instance—a service system may provide one or more “building blocks” for providing a service, such “building blocks” referred to as service instances. The service may need only one “building block” or a plurality of “building blocks”, possibly provided by different service systems.

Complex-service—a service that need to engage two or more service systems to provide a specific service to the end-user.

### BRIEF DESCRIPTION OF THE FIGURES

The features and advantages of the present invention outlined above are described more fully below in the detailed description in conjunction with the drawings where like reference numerals refer to like elements throughout, in which:

FIG. 1 is a schematic drawing of a traditional, vertical integrated network.;

FIG. 2 is a schematic drawing of a horizontally layered network comprising a service network.;

FIG. 3 illustrates the relations between basics entities of the present invention;

FIG. 4 schematically illustrates a service life-cycle;

FIG. 5 is a schematic drawing of the SCR according to the invention;

FIG. 6 is a schematic drawing of the SCR according to one embodiment of the invention;

FIG. 7 is a schematic drawing of a provisioning template according to one embodiment of the invention;

FIG. 8 is a schematic drawing of an example of service information stored in the SCR according to one embodiment of the invention; and

FIG. 9 is a schematic drawing of the UDM according to the invention.

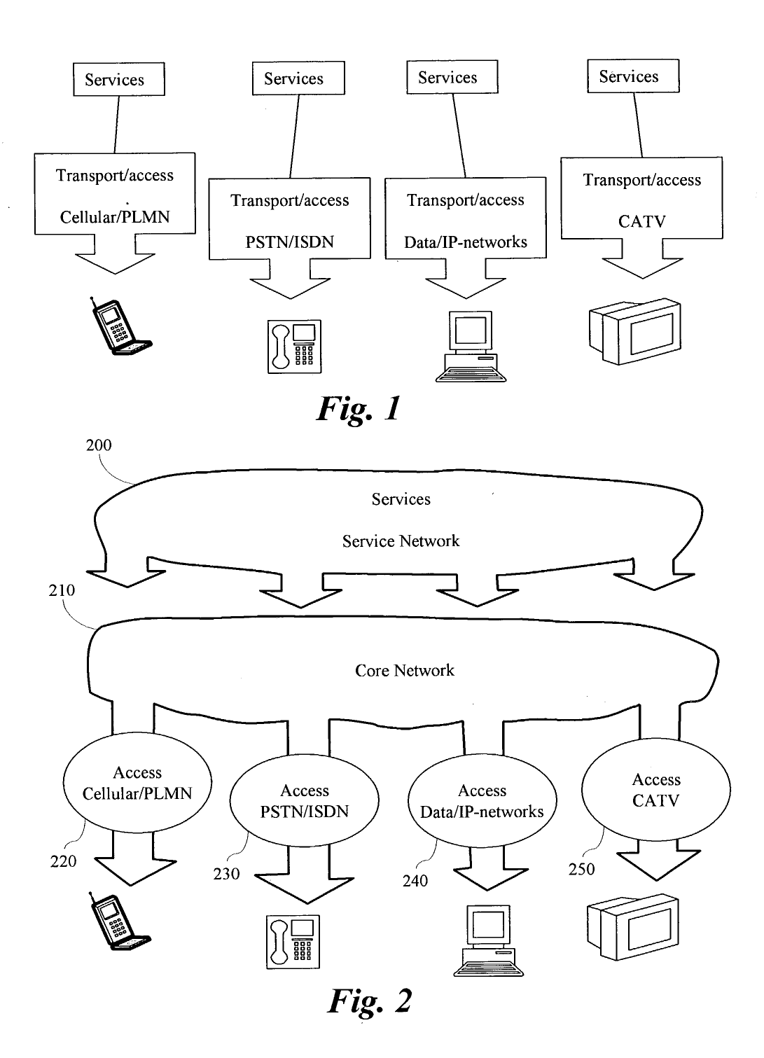

### DETAILED DESCRIPTION OF THE INVENTION

Embodiments of the invention will now be described with reference to the figures.

The control of the vast amount of various information needed for providing and executing a services in the service networks is crucial for the provisioning and the performance of the services, as described in the background section. The present invention addresses the above identified problems relating to the spreading of information in the service network, by providing a System Component Register (SCR) typically realised as a common database, for the information needed for service provisioning in a service network. The SCR comprises information on the type of services, description of the services, specification of the service system or systems in which a service is installed and a service dependencies on other services. Hence, the information needed for preferably all service provisioning in a service network can be accessed via the same entity in the network.

The service data stored in the SCR is structured according to a Service data model (SDM). It should be understood that the SCR provides information about the service as such and does not hold any information on subscribers or users. This Subscriber/user data is preferably stored in a Common Subscriber/user Database (CSD) which is separated from the SCR. It should also be understood that the SCR provides the information needed for the provisioning of a service- the actual execution of a service is handled by the service system itself, possibly with information retrieved from the CSD.

The above mentioned CSD holds common user and subscriber data that is used by a plurality of services in the service network, as well as the relationship between subscriber and users and links to affiliate data. The affiliate data is typically end-user related data that is specific for a service, or a group of services, and only relevant for a specific service system. The common user/subscriber data is stored in accordance with a User Data Model (UDM). The system, data records and method related to the user/subscriber data is described in the above referenced application XXX.

The management of data, both user/subscriber data and service data is particularly critical in the provisioning of complex services. Complex service often require involvement of two or more systems for providing services, as for example in the previously described example of booking a hotel. A positioning based service would typically involve the systems mobile positioning centre, MPC and the home subscriber server, HSS, where the user's profile for the mobile network (access network) is stored. The systems like MPC and HSS are example of the previously mentioned “building blocks”, or service enablers necessary to build a complex service. Another example of a shared resource utilized by a plurality of complex services is a calendar. A user typically wants only one calendar showing all entries regardless of how the different entries have been created. In the above example of booking a hotel, the service booking a hotel preferably also access the calendar to automatically enter the reservation. The user uses the same calendar to book meetings, remember birthdays etc. In a business scenario a subscriber may want all its users to have access to a common calendar, or each others calendars, to be able to use functions that for example automatically checks when a group of users are free to have a meeting. Hence, the service “calendar” can depending on the use, be regarded as a stand-alone service, or a “building block”, or service enabler, for complex services. In order to prevent that data necessary for one service system is changed or removed by another, for example that one service system which uses the MPC terminates the subscription/activation of the MPC if another service system needs the subscription/activation to perform its complex service, the dependencies between the service systems have to be specified.

The relations between services, service systems and service instances is further illustrated by the following example. The two services Local Movie Service and News Update Service are offered uses service system A and B, News Update Service uses service system B and C. Hence the Local Movie Service has two service instances, one in service system A and one in service system B. News Update also needs two service instances, one in service system B and one in service system C.

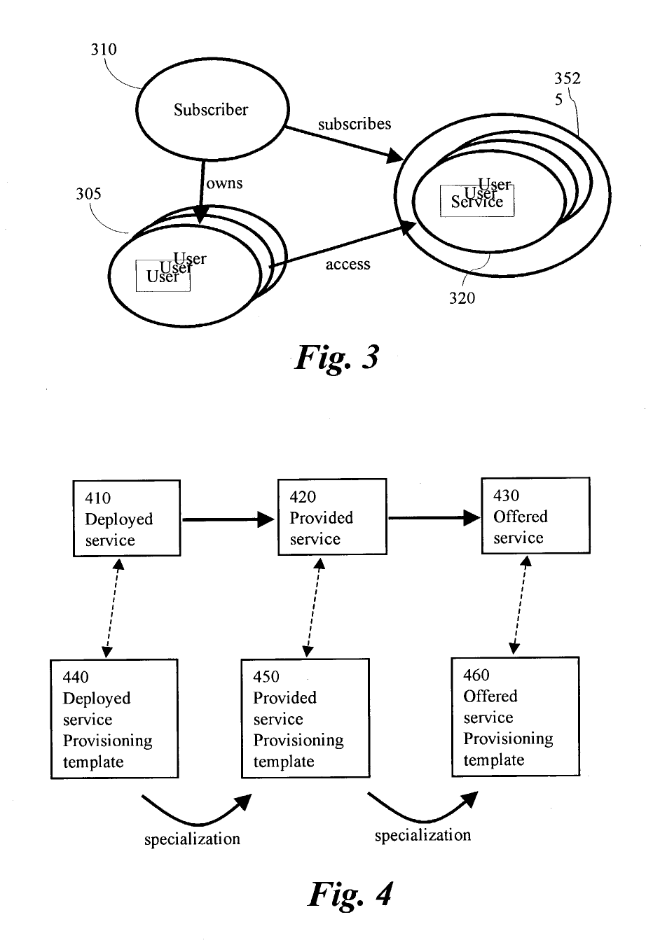

Three basic entities are important in understanding how services are deployed, provided and offered in the service network. The three entities, the subscriber, the user and the service, and their relations are illustrated in FIG. 3. The entity subscriber 310 subscribes to one or more sets or packages of services 325 provided in the service network. The subscriber 310 owns one or more users 305. The user 305 are the one actively taking advantage of a service 320. The user can only use services belonging to the set of service 325 the subscriber 310 subscribes to. The user 305 will always have to belong to a subscriber 310. The subscriber 310 will always own one or more users 305. In many cases the subscriber 310 and the user 305 will be the same person, but for e.g. a business subscriber the subscriber may be the company and the users will be the employees of the company.

The service data is stored according to a Service Data Model, SDM, resulting in a Service Data Record, SDR, stored in the SCR. In order to understand the inventive concept of providing an SCR it is useful to describe the life-cycle of a service in the service network, from conception of a new service to the service being offered to an end-user. The services are entered to the SCR and evolved within the SCR with the aid of provisioning templates. The provisioning templates define the information needed by a service system, i.e. the template provides information on the affiliate data to be provisioned for that service, as well as the provisioning operations that are supported by the system hosting the service.

Hence, the provisioning templates not only provides information on what data should be provisioned, but also how it should be provisioned. A new service can be pictured as evolving in the following steps, described with reference to FIG. 4, wherein the steps describes a method of provisioning a service in a service network according to the invention:

Deployed service (410). Then a new service has been developed it is introduced in the service network as a deployed service. The deployed service is a first representation of a service and typically a plurality of different configurations of the service are possible. The deployed service has been installed and registered in the service network. Each deployed service preferably have an associated provisioning template, the deployed service provisioning template 440. The main purpose of this template is to describe the user data that needs provisioning, and to define the operations that are supported by the service system.

Provided service 420. The provided service define different configurations of the deployed service. Each configuration represents a provided service and are a second representation of a service. The deployed service might for example allow 100 MB of storage per user for an email service, but the operator might want to limit this to 10 MB per user. This illustrates how the service should be viewed from the perspective of customer relationship management system or business management systems. A provided service provisioning template 450 is associated with the provided service. Since the provided service is a specialization of the deployed service, the provided service provisioning template 450 will be based on the deployed service provisioning template 440. It is however possible to make further specializations of the information in the deployed service template in the corresponding provided service template. A further purpose of the provided service is to do the mapping of affiliate commands and attributes to the interface that will be provided towards the business system.

Offered service 430. A provided service is presented to the user or subscriber as an offered service. The offered service represents a third representation of a service and will typically be a modification of the provided service 420 to suit a specific customer segment. This specialization will be specified by the offered service provisioning template 460.

The provisioning template for deployed 440 and provided services 450 resides in SCR, while the provisioning template for offered service 460 resides in CDS. The provisioning templates 440, 450, 460 may preferably be stored as XML files.

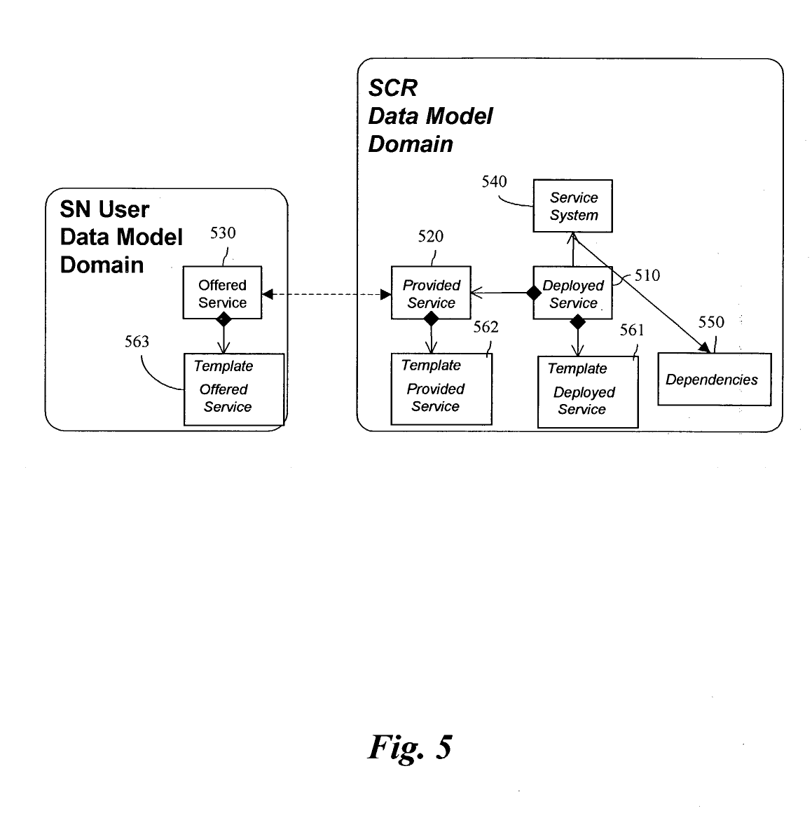

The entities in the SCR should reflect the service life cycle and define links to service instances. The implementation may vary depending on the technology used to build the CSR, but the logical grouping should be the same. The following main entities, schematically depicted in FIG. 5, should be comprised in the CSR:

Deployed service 510: contains information on a service that has been installed and registered in the service network. The entity deployed service describes all capabilities of a service and specifies all data, in particular user and subscriber data, needed to provision the service;

Provided service 520 is a specialization of the deployed service 510. The specialization is e.g. a limitation of allowed memory size for each user in an e-mail application. The specialization, e.g. limitation, is set for example by a system operator;

Service system 540, comprises information specifying the service instance and addressing means to the service instance. If viewed from an affiliate data perspective, the service system 540 specifies an affiliate instance and addressing means for the affiliate instance.

Service dependencies 550: Dependencies between services building up a complex service or using a shared resource is stored in the SCR in the entity service dependencies 550.

Templates 560: The service data will be entered to the SCR with the aid of templates. Also the specialization of a service represented by the provided service and the deployed service will be performed according to templates. The templates will preferably be stored in an format that is compact and easily exchangeable, for example as XML files (eXtended Markup Language).The provisioning templates for deployed 561 and provided services 562 resides in SCR, while the provisioning template for offered service 563 resides in CDS

Offered service 530, is a specialization of a provided service 520, reflecting an adaptation to a customer segment and or a service package. A provided service 520 may result in a plurality of offered services 530. The offered service 530 represent the connection between the data in the UDR and the SCR. Strictly, the offered service is not an entity within the SCR, it belongs to the UDM, but is included here to further illustrate the relationships to entities within the SCR (provided service 530).

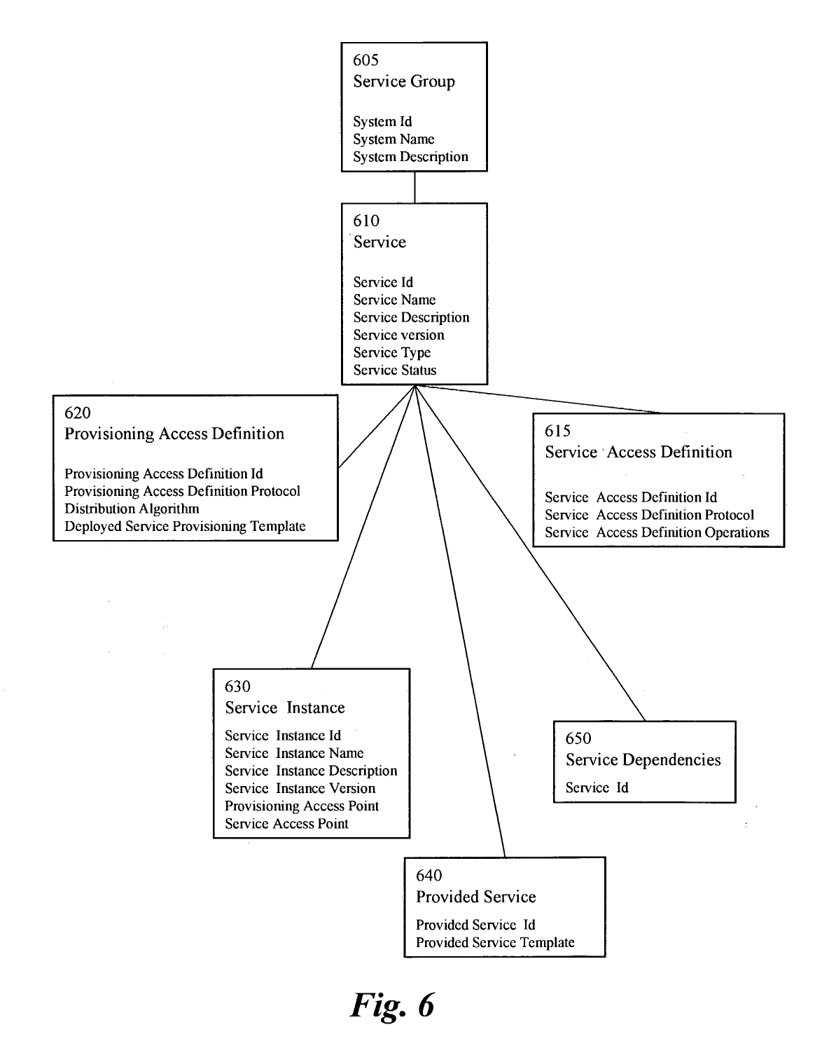

The storage of service data, including the provisioning templates, in the SCR should be in accordance to the Service Data Model, which will be described with references to FIG. 6.

The SDM comprises the below described objects. A realisation of the SCR will comprise service data records according to the SDM, which service data record will have for example fields corresponding to the below described objects. Examples of service data records for some exemplifying services are provided below. The SDM comprises the objects:

Service Group 605: The ServiceGroup object is a placeholder for services. Services from one service provider can for instance be put together under one service group while the services that belong to another service provider can be put under another service group. The management of the service group is preferably performed by a Service Administrator.

Service 610: The Service object is the placeholder for all information regarding one service. The service status attributes is mandatory and holds the status of the service.

Service Access Definition 615: For each service one Service Access Definition object can be created. The Service Access Definition object holds information about how the service is to be used.

Provisioning Access Definition 620: For each service one Provisioning Access Definition object can be created. The Provisioning Access Definition object holds information about how the service is to be provisioned. This object specify the provisioning template for the deployed service.

Service Instance 630: One service is installed on one or more service instances. The Service Instance object holds information about one service instance. Attributes of this object should specifies the service access point for the service instance and if the service requires provisioning specify the provisioning access point for the service instance.

Provided Service 640: When a deployed service is evolved to a provided service one provided service object is created for the service. An attribute should specify the provisioning template for the provided service. This provisioning template is refined from the deployed service provisioning template.

Service Dependencies 650: If the service is dependent on other services the service dependencies object is created. A mandatory multi-value attribute should specify the service identities for all dependent provided services.

Referring to FIG. 6, the Service Instance 630, and Service 610 and has a correspondence in the main entity Service System 540.

The Provisioning Access Definition 620 is created when the deployed service is created. When the provided service is created the “Provided Service” object 640 is added to the information in the SCR. Hence, the SCR data for a provided service will contain both the provided service provisioning template and the deployed service provisioning template. This is necessary if one later wants to remove the provided service but keep the deployed service information.

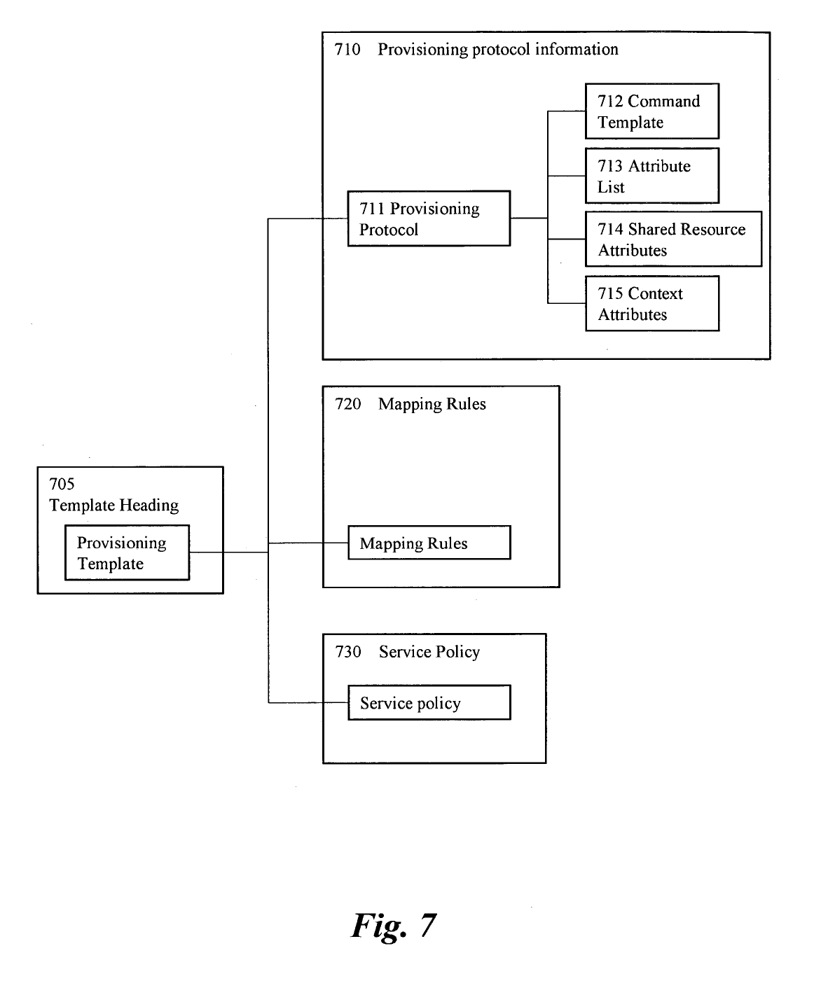

The provisioning templates are crucial for the provisioning of the correct information in each of the steps of the evolution of a service. The templates are within the SDM and the contents of the templates depends on if it is a template describing a deployed service, a provided service or an offered service. However, a general structure will be the same for all provisioning templates and will be described with references to FIG. 7.

As indicated in the figure a provisioning template 700 will comprise the following main parts:

Template heading 705, comprising a standardized XML schema header;

Provisioning protocol information 710, describing the affiliate data that needs provisioning and the provisioning requests supported;

Mapping rules720 describing how the provisioning requests supported in application (affiliate) system should be mapped towards a business management systems. Mapping rules does not exist for deployed services; and

Service Policy 730 describing when and how the service can be used.

The provisioning protocol information 710 may further comprise some of the following parts, which should be considered as examples of information provided in the provisioning protocol information 710.

Provisioning Protocol 711, deciding the provisioning interface supported by the affiliate;

Command Template 712, comprising information about the affiliate commands possible to send towards the affiliate. The contents in this section differ depending on the provisioning interface supported by the affiliate.

Attribute List 713, describing all the attribute required for provisioning of the service in the affiliate The attribute list will always contain the attribute name, data type and default values. The allowed data types of the attributes depends on the interface that will be used towards the affiliate.

Shared Resource Attributes 714, defining attributes that relates to shared resources. The shared resource attribute 714 always refer to an existing attribute in the Attribute List 713.

Context Attributes 715, is the key identifier for a user or a subscriber in the affiliate system. The context attribute 715 always refer to an existing attribute in the Attribute List 713.

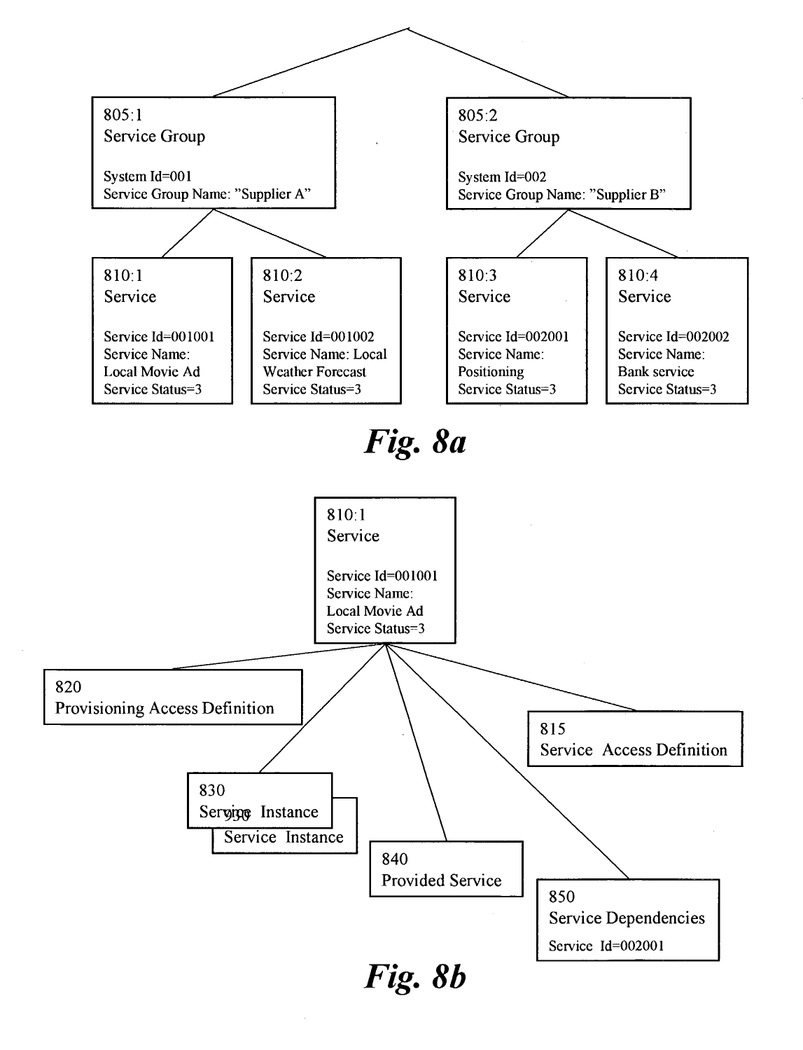

How data is stored in the SCR according to the present invention will be further illustrated in an example described with reference to FIG. 8a and b. The Data is stored in accordance with the Service Data Model, SDM, which is described with reference to FIG. 6 and FIG. 7 which also are referenced in this example. In the illustrative example the four service are stored and have corresponding data records: Local Movie Advertisement 810: 1, Local Weather Forecast 810:2, Mobile positioning 810:3 and Bank service 810:4. Each service data record comprises several attributes including a service ID, a service name and a service status. The service are grouped into two service groups, service group A 805:1 and service group B 805:2, respectively, according to supplier. Other means of grouping are possible. Each record service group comprises a service group ID and a service group name. Local Movie Advertisement 810:1 and Local Weather Forecast 810:2 belongs to service group A 805:1. Mobile positioning 810:3 and Bank service 810:4 belongs to service group B 805:2.

Each service will have more detailed service information stored, as illustrated in FIG. 8b. This information will comprise specifications on the service dependencies 850: In the example Local Movie Advertising 810:1 is dependent on Mobile positioning 810:3. This dependency is defined in the field Service dependencies 850 preferably by specifying the service ID of the service (Mobile positioning) to which local Movie Advertising is dependent.

Local Weather Forecast is dependent on Mobile positioning 830 and Bank service 840 (not shown). In this case the Service dependencies 865 will include two service ID's referring to Mobile positioning 830 and Bank service 840, respectively.

The service information provided by the service data record further comprises, in accordance with SDM (FIG. 6) the fields Provisioning Access Definition 820, Service Instance 830, Provided Service 940 and Service Access Definition. The purpose of those fields is specified above in the description of the SDM.

The separation of user/subscriber information (stored in CSD), service information (stored in SCR) and affiliate data is an important part of the inventive concept of the present invention. To illustrated the relationships between the CSD and the SCR a description of the CSD and the User data model will be given.

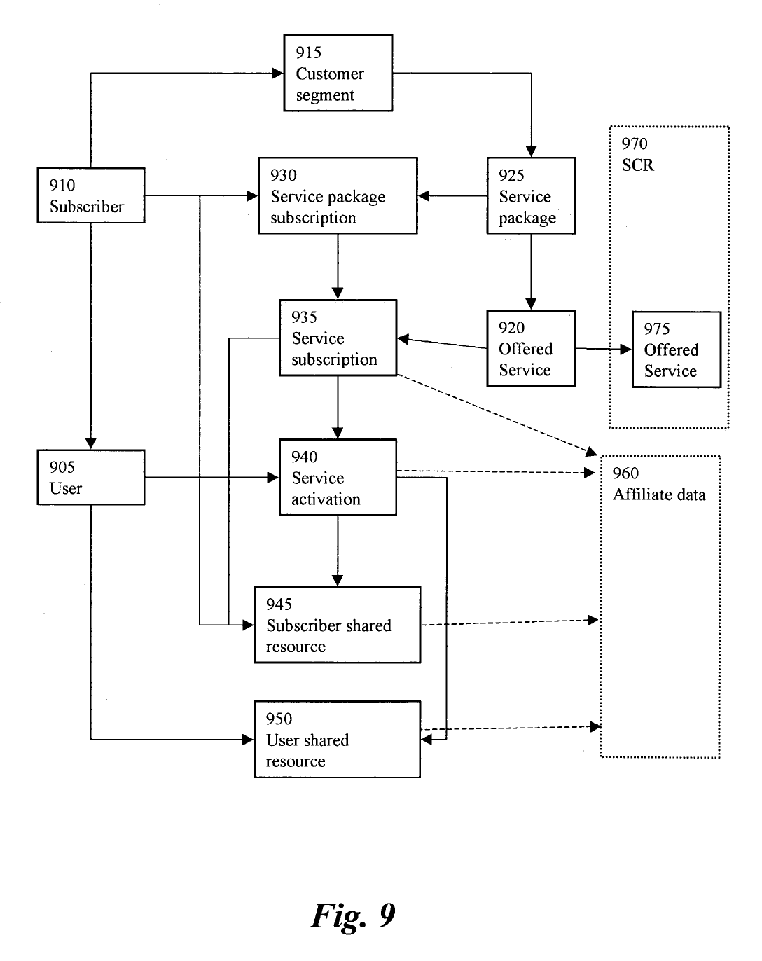

The user/subscriber data is stored according to a User Data Model, UDM, resulting in a User Data Record, UDR, stored in the CSD that comprises actual user-related data and end-user subscriptions to services. The principle of the user data model will be described with references to FIG. 9. The user data record, UDR will be constructed after the principles of the UDM. The structure of the data stored in the CSD has to be carefully designed, to avoid internal replication of data, provide the correct links to the systems for providing services and maintaining the needed data in the most logical way. The data is logically grouped into objects, with key objects being subscriber, user and service, in correspondence to the main entities described above. An object corresponds to a field in the UDR. The arrows in the figure indicates links between the objects. The implementation may vary depending on the technology used to build the CSD, but the logical grouping should be the same.

The following objects should preferably be comprised in the UDM:

User 905: contains basic User information (e.g. user identities). A user 905 is always belonging to a subscriber 910;

Subscriber 910: contains basic Subscriber information (e.g. subscriber identities);

Customer Segment 915: used to classify subscribers 910. Contains customer segment description and basic data;

Offered Service 920: contains service basic information;

Service Package 925: used to package services 920;

Service Package Subscription 930: used to reflect an effective subscription to a service package 925 by a subscriber 910;

Service Subscription 935: used to reflect effective subscriptions to individual services 920 in a service package by a subscriber, specified by the service package subscription 930;

Service Activation 940: used to reflect effective activation to an individual service from the service subscription 935 by an user 905;

If dependencies between service systems are to be handled within the UDR the Subscriber Shared Resource 945 contains basic data of the shared resource being used in a certain service subscribed by a subscriber 910 and specified by the service subscription 935; and

User Shared Resource 950: contains basic data of the shared resource being used in a certain service activated 940 by an user 905.

The user object 905 and the subscriber object 910 are examples of identification objects. The service subscription object 935 and the service activation objects 940 are examples of service objects. All services present in the service network 200 is known by the UDM. The subscriber 910 may then subscribe to a service. The object offered service 920 contains information on all the offered services and hold references or links to service data stored in the SCR 970, represented by the object provided service 975 (640). This is preferably the only direct link between the UDR data and the SCR. A subscriber 910 could subscribe to services one by one, but this would make the provisioning cumbersome. Preferably similar services, or service likely to attract the same subscriber, are grouped together which is reflected in the object service package 925. A certain service may be offered in a plurality of service packages. Additionally, a service package may be offered to a group of subscribers with the same characteristics and expected needs. Hence, subscribers 910 may be grouped into customer segment 915, and the subscriber 910 may subscribe to all services offered to the customer segment it belongs to. A service is added to a customer segment by including it in one or more service packages 925. In short, service packages 925 groups services 920 and customer segment 915 groups subscribers 910.

Referring to the example of offered service described with reference to FIG. 9, Local Movie Advertisement 910:1, Local Weather Forecast 910:2, Mobile positioning 910:3 and Bank service 910:4 are registered in the CSD through the offered service 920. The services may in addition be registered as a service package, specified in service package 925, for example a packaged called “localised service” and including the services Local Movie Advertisement and Local Weather Forecast.

The service component register and the service data records facilitate a centralized provisioning of services in the service network. Through the UDM the services are offered to the end-users in a unified way. By these arrangement a stable environment is created in the service network and a fast and secure provisioning of services is assured.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

Example of a Use Case

Pre-conditions:

A detailed example of a typical provisioning scenario is given, in which an end-user activates the local weather forecast service. The example is based on the following prerequisites:

The offered services and services has been set up as described above.

A subscriber has been created.

Users belonging to the subscriber has been created.

The subscriber belongs to a customer segment that is allowed to provision the “Localised services” service package.

The subscriber belonging to our end-user has subscribed the “localised services” service package.

Flow of Event:

Below is a description of the typical flow of events when an end-user subscribes to the service. The exact behaviour will depend on the customer specific set up of the service network.

1. The end-user wants to browse for new services available on his portal, and uses a WAP (Wireless Application Protocol) terminal to access the portal home page.

2. The portal will request the available services for this user by sending a CAI3G request to CPE.

3. CPE will check what services that are available for this user by checking the contents of the service packages subscribed by the subscriber the user belongs to. This information resides in the CSD.

4. CPE responds with a CAI3G response to the Portal.

5. The Portal creates a WAP page with information about the available services. Note, the response from CPE only contains the information to present to the end-user. It does not contain any information about how it should be presented. The Portal should solve this itself by using technologies like style sheets and a terminal databases.

6. The end-user finds the local weather forecast service and the local movie advertising service. He decides to activate the local weather forecast service.

7. The Portal requests the service parameters for this service from CPE.

8. CPE will look in SCR to find any service dependencies. The local weather forecast service depends on the positioning service and a bank service.

9. CPE checks if the end-user already has subscribed the positioning service and the bank service. Since a bank service subscription already existed in CSD, this subscription will be re-used, but a positioning service will have to be created.

10. CPE reads the offered service provisioning template for the local weather forecast service and the positioning service. This information is stored as XML files in CD. The XML files will follow the format decided by the offered service XML schCPEs.

11.CPE will concatenate the attribute information from the two templates in a new XML string, and return this to the Portal.

12. The Portal will create a new WAP page with an input field for every attribute it finds in the XML response from CPE. It will put a label corresponding to the attribute name, and an input field that suits the data type of the attribute.

13. The end-user will fill in all the input fields in the GUI and click the OK button.

14. The Portal will validate the data according to the attribute information that was provided by CPE. It will check that all mandatory attributes has been filled in, and that all data is within the specified valid ranges.

15. The Portal sends a CAI3G request to create the subscription towards CPE. As an input parameter it will include the XML string with all filled-in end-user data.

16. CPE will get service instance data from SCR and select the most appropriate instance to provision the user to. This will be done based on the result of the distribution algorithm (also found in the SCR).

17. CPE creates the affiliate provisioning commands according to the deployed service provisioning template found in the SCR.

18. CPE sends the provisioning commands towards affiliates (using CAI3G, CAI or LDAP)

19. CPE updates the user's data in CD.

20. CPE updates E-AAA.

21. CPE sends an OK response to the Portal

22. CPE notifies CAS (Customer Administrative System) (if the CAS has subscribed to notifications on this type of events)

1. A system adapted for provisioning services in a service network with a plurality of service systems for providing a plurality of services, wherein the system comprises a system component register (SCR) comprising service information relating to a plurality of services in the service network, said service information is stored in service data records, one for each service or group of services, and wherein each service data records comprise:
at least one service instance field identifying a service instance for the specific service or group of services; and
at least one dependency field defining dependencies for the specific service or group of services to at least one other service system in the service network, if the specific service or group of services is a complex service or utilizes a shared resource, whereby the service component register and the service data records facilitate a centralized provisioning of services in the service network.

2. System according to claim 1REFMERGEFORMAT, wherein the service data record further comprises:
a service field s, which holds information regarding one service;
a service access definition field, which holds information about how the service is to be used;
a provisioning access definition field, which holds information about how the service is to be provisioned.

3. System according to claim 2, wherein the service data record further comprises the fields:
deployed service field, which comprises information on a service that has been installed and registered in the service network.; and
provided service field, which represent a specialization of the deployed service.

4. System according to claim 2REFMERGEFORMAT, wherein the service data record further comprises a template field specifying provisioning templates relevant for the service, said provisioning templates defining the information needed to provision a service and the provisioning operations supported by the service system.

5. System according to claim 4, wherein the provisioning templates are stored in the SCR.

6. System according to claim 4, wherein the provisioning templates are stored in an format that is compact and easily exchangeable, for example as XML files (eXtended Markup Language).

7. System according to claim 2, wherein the provisioning access definition field further specify the provisioning template for a deployed service.

8. System according to claim 1REFMERGEFORMAT, wherein the service data record further comprises a service group field identifying at least two service that are grouped together.

9. A service data model adapted to be used for provisioning services in a service network with a plurality of service systems for providing a plurality of services, wherein the service data model comprises service information relating to a plurality of services in the service network, said service information is structured in service data objects, one for each service or group of services, and wherein each service data object comprise:
at least one service instance object identifying a service instance for the specific service or group of services; and
at least one dependency object defining dependencies for the specific service or group of services to at least one other service system in the service network, if the specific service or group of services is a complex service or utilizes a shared resource, whereby the service data model facilitate a centralized provisioning of services in the service network.

10. Data model according to claim 9, wherein the service data object further comprises:
a service object, which holds information regarding one service;
a service access definition object, which holds information about how the service is to be used;
a provisioning access definition object, which holds information about how the service is to be provisioned.

11. Data model according to claim 10, wherein the service data record further comprises the objects:
deployed service object, which comprises information on a service that has been installed and registered in the service network.; and
provided service object, which represent a specialization of the deployed service.

12. Data model according to claim 9, wherein the service data object further comprises a template object specifying provisioning templates relevant for the service, said provisioning templates defining the information needed to provision a service and the provisioning operations supported by the service system.

13. Data model according to claim 12, wherein the provisioning templates are stored in the SCR.

14. Data model according to claim 12, wherein the provisioning templates are stored in an format that is compact and easily exchangeable, for example as XML files (eXtended Markup Language).

15. Data model to claim 10, wherein the provisioning access definition object further specify the provisioning template for a deployed service.

16. Data model according to claim 9, wherein the service data object further comprises a service group object identifying at least two service that are grouped together.

17. A method of provisioning services in a service network, wherein service information relating to a plurality of services are stored in a system component register (SCR), the method comprising the steps of:
deploying the service in the service network by providing a first representation of the service in the SCR;
providing the service by providing a second representation of the service in the SCR, the second representation of the service being a specialization of the first representation.

18. The method according to claim 17 further comprising the step of:
offering the service to end-users, by providing a third representation of the service in a common subscriber/user database (CSD), the third representation of the service being an specialization of the second representation of the service.

19. The method according to claim 17 wherein the step of deploying the service is performed by using a deployed service provisioning template, which specify user data to be provisioned and to define the operations that are supported by the service system providing the service.

20. The method according to claim 17 wherein the step of providing the service is performed by using a provided service provisioning template.

21. The method according to claim 18 wherein the step of offering the service is performed by using a offered service provisioning template.
